(19) United States
(12) Patent Application Publication
(10) Pub. No.: US 2013/0157499 A1
(43) Pub. Date: Jun. 20, 2013

(54) ACTIVE ELECTRICAL CONNECTION WITH SELF-ENGAGING, SELF-RELEASING HEAT-SINK

(71) Applicants: Martin J. Crippen, Apex, NC (US); Karl K. Dittus, Durham, NC (US); Tony C. Sass, Fuquay Varina, NC (US)

(72) Inventors: Martin J. Crippen, Apex, NC (US); Karl K. Dittus, Durham, NC (US); Tony C. Sass, Fuquay Varina, NC (US)

(73) Assignee: INTERNATIONAL BUSINESS MACHINES CORPORATION, Armonk, NY (US)

(21) Appl. No.: 13/330,963

(22) Filed: Dec. 20, 2011

(51) Int. Cl. H01R 13/00

(52) U.S. Cl. 439/487

(57) ABSTRACT

An active electrical connection system includes a first connector, a second connector for releasably connecting with the first connector, active circuitry for affecting a data signal, and a heat sink for dissipating heat. A heat sink positioning system comprising a plurality of protrusions and corresponding recesses precisely positions the heat sink during insertion to prevent sliding contact with a thermal interface material applied between the heat sink and a plug.

### BACKGROUND

1. Field of the Invention

The present invention generally relates to electrical connectors, and more particularly to a thermal interface for cooling electrical connectors.

2. Background of the Related Art

A data cable is an electronic cable having electrically conductive signal lines that provide an electronic data pathway between two devices. A data cable commonly has a connector on at least one end for removably connecting to a corresponding connector on one device. The other end of the data cable is either hard-wired to the other device or has another connector for removably connecting to the other device. Many standard connector types are used in data cables, examples of which include Universal Serial Bus (USB), Digital Video Interface (DVI), and High-Definition Multimedia Interface (HDMI). Cables that passively carry signals on conductive pathways commonly degrade the data being transmitted, due to channel impairment phenomena such as attenuation, crosstalk and group velocity distortion. These inherent limitations of common conductive materials limit the length and performance of passive data cables.

Active cables have been developed that include an embedded semiconductor chip in the connector body to boost the signal performance. The chip includes embedded active circuitry that boosts and clarifies the signal being transmitted. Active cables can use copper signal lines or an optical medium, such as glass fibers, to carry data. The active circuitry can decrease the amount of copper required relative to passive copper data cables. The optical fibers used in active optical cables have much lower transmission losses than metal wires. As a result, both copper and optical active cables can be made thinner, longer, or faster than a passive version of the cable. Some commercially available active cables, for example, can be more than five times as long. However, the active circuitry in the connector body consumes electricity and generates heat. In some active cables, a heat sink is therefore provided to dissipate the heat generated by the active circuitry. The heatsink is typically inside the computer system or hardware device that the cable plugs into, so that the system can cool the cable via the heat sink.

### BRIEF SUMMARY

A disclosed active electrical connection system includes separable first and second connectors. The first connector includes a plug, and the second connector includes a socket configured for receiving the plug to a connected position within the socket. Active signal processing circuitry is provided, in electronic communication with one or both of the first and second connectors, for processing a data signal transmitted between the first and second connector. A heat sink includes a heat sink base secured to the second connector. The heat sink base is positioned for sliding engagement with the plug at a mechanical interface between the base and the plug as the plug is moved to the connected position within the socket. A plurality of corresponding protrusions and recesses are provided at the mechanical interface between the base and the plug. These include, at least, protrusions on one of the heat sink base and the plug and recesses on the other of the base and the plug. The protrusions are vertically misaligned with the corresponding recesses upon entry of the plug into the socket to urge the heat sink away from the plug. The recesses are vertically aligned with the protrusions to receive the protrusions when the plug reaches the connected position.

### BRIEF DESCRIPTION OF THE SEVERAL VIEWS OF THE DRAWINGS

FIG. 1 is a perspective view of an active cable connection system, with a plug of a first connector in a connected position within a socket of a second connector.

FIG. 2 is a perspective view of the active cable connection system, slightly rotated and enlarged for detail relative to FIG. 1.

FIG. 3 is a perspective view of the heat sink with a thermal interface material (TIM) to be applied to a lower surface of the base.

FIG. 4 is a perspective view of the first connector and a cutaway view of the heatsink with other features of the second connector of FIG. 2 removed.

FIG. 5 is a sectioned side view of the active cable connection system, with the plug of the first connector partially inserted within the socket of the second connector.

FIG. 6 is a sectioned perspective view of the active cable connection system, with the plug of the first connector further moved to the connected position within the socket of the second connector.

### DETAILED DESCRIPTION

An active electrical connection system is disclosed that includes a heatsink positioning system responsive to the connection and disconnection between first and second connectors. The active electrical connection system also provides an improved mechanical and thermal interface between the heatsink and one of the first and second connectors. The first connector may be a plug, and the second connector may be a socket for receiving the plug. The active electrical connection system may be used, for example, in the context of connecting an active data cable to a computer system or hardware device, where the first connector is on the active data cable and the second connector is on the computer system chassis or hardware device chassis.

In a disclosed example embodiment, the first connector includes a plug on an active data cable and the second connector includes a socket for releasably receiving the plug. The heatsink is movably supported on the second connector. As further detailed below, a heatsink positioning system comprises a plurality of protrusions provided on one (or both) of the plug and the heat sink base, that cooperate with corresponding recesses on the other of the plug and the heat sink base, to precisely position the heat sink base relative to the plug as the plug is moved within the socket. The protrusions on the plug and/or heat sink base are located so that they will cause the heat sink base to move upward slightly upon insertion of the plug, against the force provided by a biasing member, such as one or more spring fingers. The protrusions will maintain the raised position of the heat sink base until the plug reaches the connected position within the socket, at which point the protrusions vertically align with corresponding recesses. When the protrusions vertically align with the corresponding recesses, the protrusions are received into the corresponding recesses as the heat sink base is urged by the spring fingers into thermal engagement with the plug. This precise positioning of the heat sink prevents shearing forces that can damage a thermal interface material applied to a mechanical interface between the heat sink base and the plug.

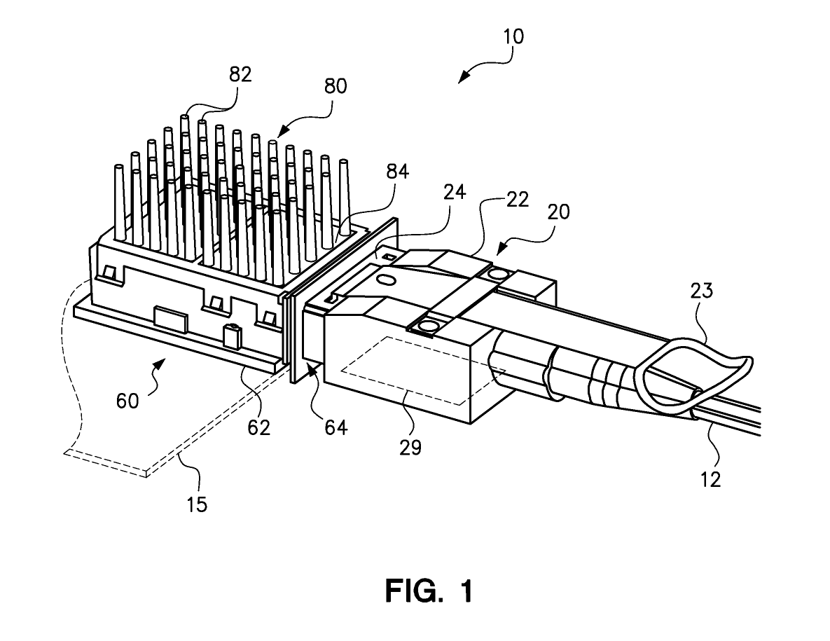

FIG. 1 is a perspective view of an active electrical connection system 10 with a plug 24 of a first connector 20 in a connected position within (i.e. plugged into) a socket 64 of a second connector 60. The plug 24 is mostly hidden from view within the socket 64 in the connected position of FIG. 1. The first connector 20 is provided on an end of an electronic data cable 12. The first connector 20 includes a connector housing 22, which may be made of a durable, electrically insulating material such as plastic to encapsulate and protect sensitive internal electronic components of the first connector 20. The second connector 60 includes a mount 62 for mounting the connector 60 to the circuit board 15. Electrical terminals (not shown) may be included on the mount 62, such as a pin grid array, placing the second connector 60 in electrical communication with other circuit board components along electronic pathways provided on the circuit board 15. As an example implementation, the circuit board 15 may be the circuit board of an adapter card or application card, wherein the socket 64 of the second connector 60 is positioned to be externally accessible to a chassis (not shown) for easy connection and disconnection with the first connector 20 on the cable 12. The plug 24 may be removed from the socket by pulling a pull tab 23.

A heat-generating component is provided in the first connector. In this example embodiment, the heat-generating component comprises active circuitry included within the active electrical connection system to control a data signal, such as to boost and clarify a data signal being transmitted across the connection between the first and second connectors 20, 60. The active circuitry may include circuit elements on one or both of the first and second connectors 20, 60. The active circuitry may include a microcontroller chip 29 which performs signal processing, such as to amplify, filter, or otherwise clarify the transmitted signal. The chip 29 is typically in the body of the first connector 20, as it is in this embodiment, although elements of a heat-generating component may also be located on the second connector 60 or within the distal end of the plug 24 that is received within the socket 64.

The active circuitry generates heat, which may be due to active signal processing on the chip 29, increased current flow through the first and second connectors 20, 60 from the boosted signal, from, or a combination thereof. A heat sink 80 is mounted on the second connector 60 for dissipating the heat generated by the active electrical connection system 10. When the plug 24 is connected within the socket 64, the base 84 of the heat sink 80 thermally engages the plug 24 to conduct heat away from the plug 24. The heat sink 80 includes a plurality of heat sink fins 82 coupled to the heat sink base 84. The fins 82 conduct heat away from the base 84 and collectively provide a large amount of surface area exposed to open air for convective cooling of the active electrical connection system 10. For example, the heat sink 80 may be located within a chassis having forced air flow that passes across the heat sink fins 82.

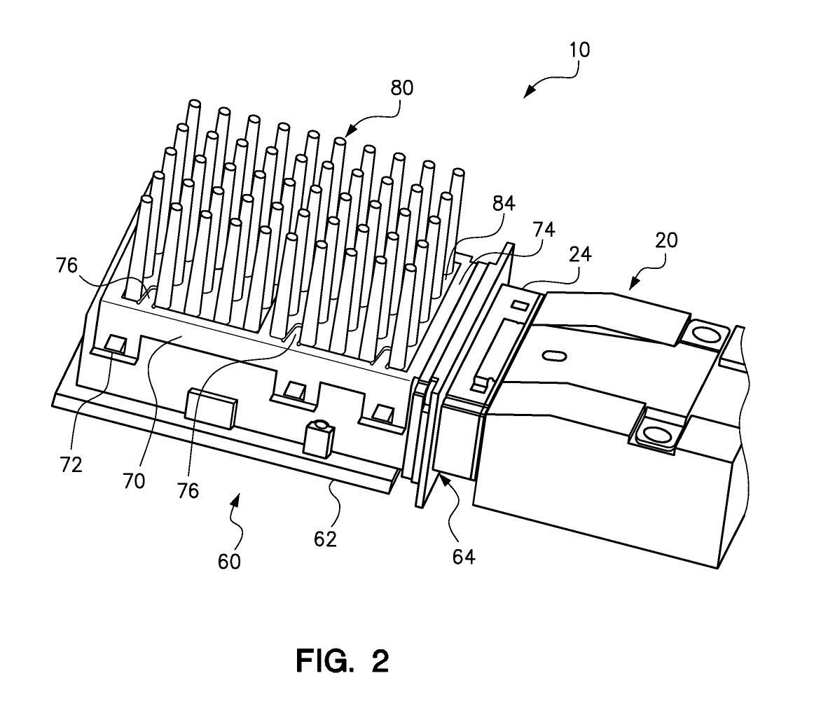

FIG. 2 is a perspective view of the active electrical connection system 10, slightly rotated and enlarged for detail relative to FIG. 1. The plug 24 is still in the connected position within the socket 64. A heat sink retainer 70 secures the heat sink 80 to the mount 62 of the second connector 60. The retainer 70 is fastened to the mount 62 with a plurality of tab fasteners 72. The retainer 70 includes a collar 74 about a periphery of the base 84. The collar 74 may slightly overlap a peripheral edge of the heat sink base 84, to retain the heat sink 80 on the second connector 60. A biasing member is provided to urge the heat sink 80 into thermal engagement with the plug 24. The biasing member may take any of a variety of different forms, but is embodied here as a plurality of spring fingers 76 unitarily formed with the collar 74. The spring fingers 76 extend inwardly from the collar 74, overlapping the base 84. The spring fingers 76 may be provided in several peripherally-spaced positions along the collar 74 to provide a generally uniform downward force on the heat sink base 84. The spring fingers 76 are formed of an elastic material such as a flexible steel alloy or plastic, having sufficient rigidity to collectively urge the heat sink base 84 into thermal engagement with the plug 24 when the plug is received below the heat sink base 84, but are compliant enough to accommodate slight movement of the heat sink 80 up and down relative to the plug 24, as further described below, without plastically deforming. The spring fingers 76 may be sufficiently elastic and fatigue-resistant to be repeatedly flexed over the course of many (e.g. hundreds or thousands) connection and disconnection cycles between the first connector 20 and the second connector 60.

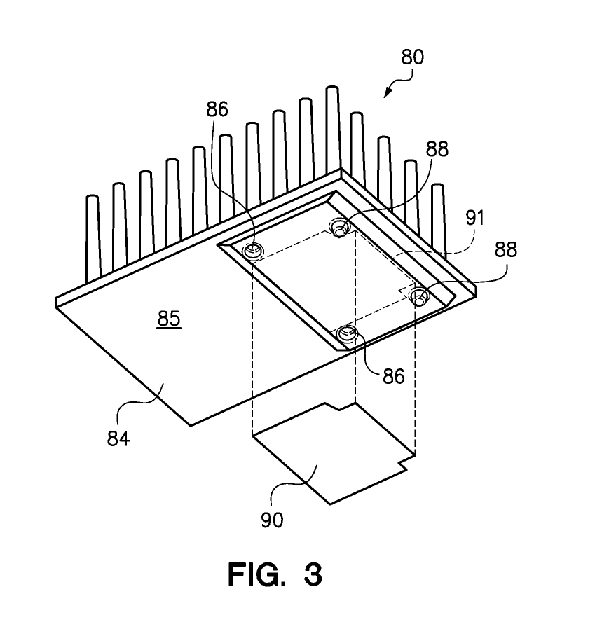

FIG. 3 is a perspective view of the heat sink 80 with a thermal interface material (TIM) 90 to be applied to a lower surface 85 of the base 84. The TIM 90 is applied to a designated area 91 of the lower surface 85 of the heat sink base 84, inside a boundary defined by protrusions 88 and recesses 86. Generally, the TIM 90 is a thermally conductive material that may be applied to increase thermal conductance between two adjacent solid surfaces. As described below, the lower surface 85 of the base 84 forms a mechanical interface (and a thermal interface) with an upper surface of the plug, so the TIM 90 promotes heat transfer at that mechanical interface. The TIM 63 may also help fill any gaps that may be present between the plug and the lower surface 85 at this location, since air is a very poor conductor. One common TIM is a paste or thermal grease, such as silicone oil filled with aluminum oxide, zinc oxide, or boron nitride. However, another TIM is a gap pad, which can be pre-formed to match the geometrical shape of the designated area 91. The thickness of the TIM 90 is preferably less than a height of the protrusions 88. Any TIM in excess of the height of the protrusions 88 will be scraped by the surface of the plug as it slides along the lower surface 85 of the heat sink base 84.

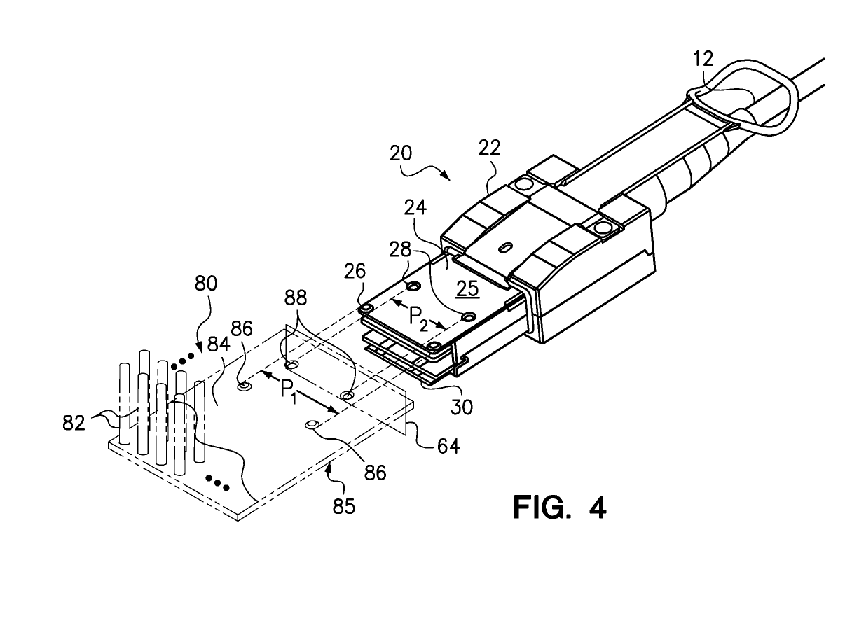

FIG. 4 is a perspective view of the first connector 20 and a cutaway view of the heatsink 80 with other features of the second connector 80 of FIG. 2 removed. An entrance of the socket 64 is traced for reference. The heat sink 80 is aligned with the plug 24 as it might be when inserting the plug 24 into the socket 64. An upper surface 25 of the plug 24 and the underside or lower surface 85 of the heat sink base 84 define a mechanical interface between the plug 24 and the heat sink base 84. The protrusions and recesses cooperate to position the heat sink 80 as the plug 24 is moved within the socket 64 to the connected position. The protrusions and recesses may be provided in any of a variety of different patterns or configurations. By way of example, this embodiment includes a pair of protrusions 26 on the upper surface 25 of the plug 24 that correspond to a pair of recesses 86 on the lower surface 85 of the heat sink base, and a pair of recesses 28 on top of the plug 24 that correspond to a pair of protrusions 88 on the lower surface 85 of the heat sink base 84. The pair of protrusions 26 on the plug 24 and the corresponding pair of recesses 86 on the base 84 are both spaced at a first pitch (or distance) P1. The pair of recesses 28 on the plug 24 and the corresponding pair of protrusions 88 on the base 84 are spaced at a second pitch P2. P1 and P2 are unequal; more specifically, P1 is greater than P2 in this embodiment. During an insertion of the plug 24 into the socket 64, the protrusions 26 on the plug 24 are horizontally aligned with the corresponding recesses 86 on the base 84, i.e. in a plane of the mechanical interface between the plug 24 and the lower surface 85 of the base 84. Likewise, the recesses 28 on the plug 24 are horizontally aligned with the corresponding protrusions 88 on the base 84.

The protrusions 26 on the plug 24 are near a leading end 30 of the plug 24 that is first to enter the socket 64. Prior to reaching the fully connected position, the protrusions 26 on the plug 24 are vertically misaligned with the recesses 86 on the base 84, and the recesses 28 on the plug 24 are vertically misaligned with the protrusions 88 on the base 84. Thus, as the plug 24 is inserted, the protrusions 26 initially contact the lower surface 85 of the base 84, urging the base 84 slightly upward. As the plug 24 is moved further inside the socket 64, the protrusions 26 slide along the lower surface 85 of the base 84. Because the protrusions 26 on the plug 24 are at a wider pitch P2 than the protrusions 88 on the base 84, the protrusions 26 on the plug 24 are allowed to slide past the protrusions 88 on the base 84, without interference. Just as the plug 24 reaches the connected position, the protrusions 26 on the plug 24 become vertically aligned with the corresponding recesses 86 on the base 84. Simultaneously, the recesses 28 on the plug 24 become vertically aligned with the protrusions 88 on the base 84. This vertical alignment of protrusions and corresponding recesses allows the base 84 to be urged by the biasing member into thermal engagement with the upper surface 25 of the plug 24.

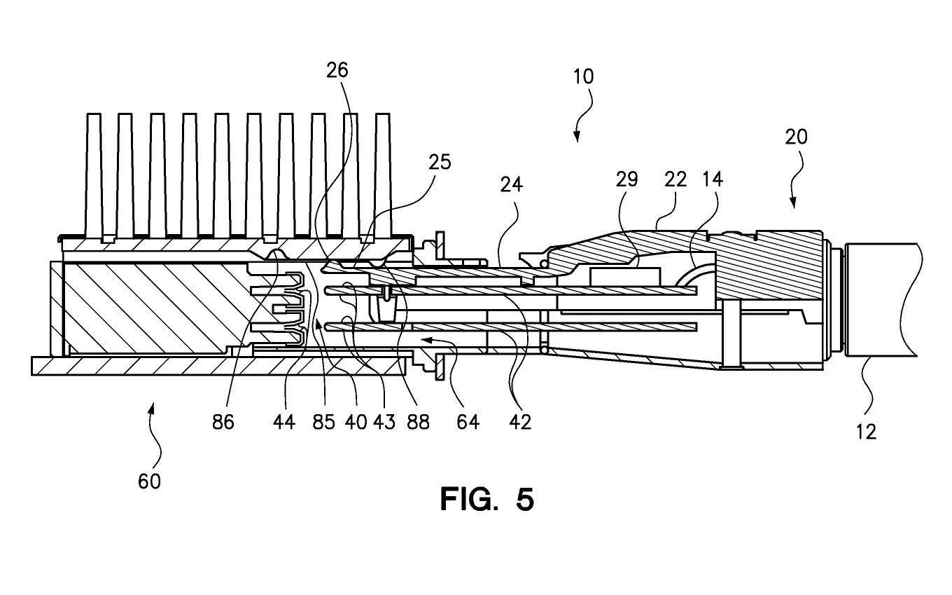

FIG. 5 is a sectioned side view of the active electrical connection system 10, with the plug 24 of the first connector 20 partially inserted within the socket 64 of the second connector 60. The heat sink 80 is raised as a result of the protrusions 26 on the plug 24 engaging the lower surface 85 of the base 84, and the protrusions 88 on the base 84 engaging the upper surface 25 of the plug 24. This creates a gap between the lower surface 85 of the base 84 and the upper surface 25 of the plug 24, to prevent the TIM 90 of FIG. 3 from being subjected to shear forces, which may cause the TIM to be scraped off, when connecting and disconnecting the two connectors 20, 60. The protrusions 26, 88 may be all the same height, so that the lower surface 85 of the heat sink base 84 will be generally parallel to the upper surface 25 of the plug 24 when the base 84 is biased into thermal engagement with the plug 24. It should be recognized that the base 84 may initially tilt due to the protrusions 26 engaging only the leading edge of the base.

FIG. 5 also illustrates an electrical interface 40 provided between the first connector 20 and the second connector 60. The electrical interface 40 will typically include a plurality of electrical plug contacts in the form of one or more card 42, which in this embodiment comprises two cards, each with gold tabs on either side of each card. The gold tabs engage corresponding socket contacts, which in this embodiment comprise conductive leaf spring contacts 44 in the socket 64, when the plug is moved to the connected position within the socket. This is just an example arrangement of mating electrical contacts, and one of ordinary skill in the art will appreciate that a wide variety of different arrangements of contacts are possible.

The cable 12 includes any number of signal lines 14, which may comprise copper wires or optical fiber, for example. The signal lines may extend along the cable 12, through the connector housing 22 and plug 24, and typically terminate to one or more card 42 which has the active circuitry components 29 on it. In this embodiment, the plug contacts 43 provided by the cards 42 (shown on both sides of each card) are positioned to automatically engage the socket contacts provided by the leaf spring fingers 44 in response the plug having been moved to the connected position within the socket. Alternatively, a zero insertion force embodiment may allow for a separate, moveable engagement and disengagement between plug and socket contacts while the plug and socket remain stationary in the connected position.

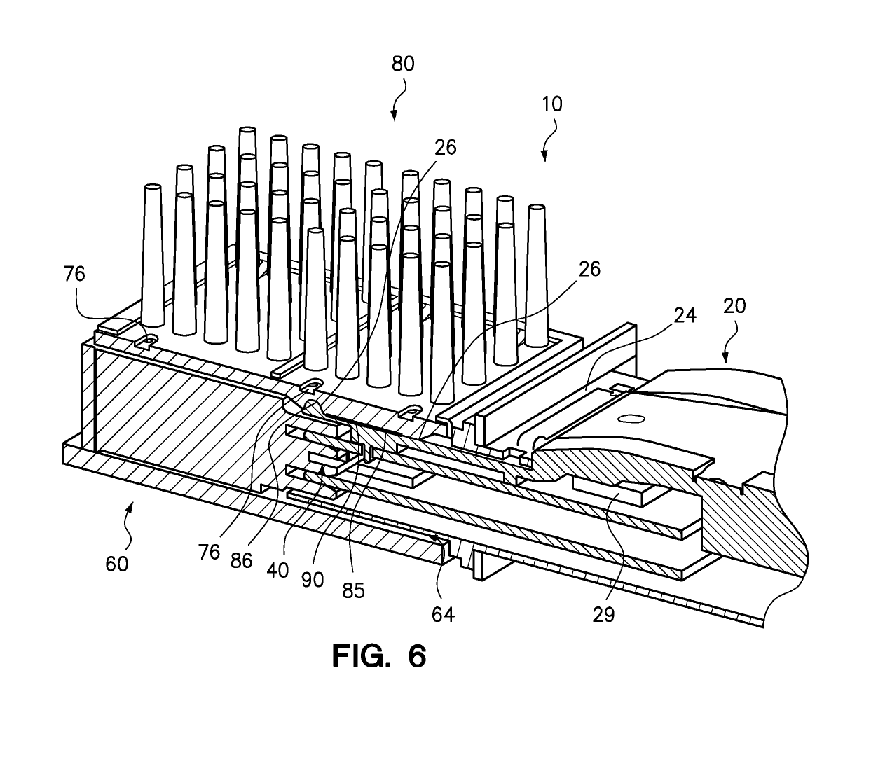

FIG. 6 is a sectioned perspective view of the active electrical connection system 10, with the plug 24 of the first connector 20 further moved to the connected position within the socket 64 of the second connector 60. The first and second connectors 20, 60 are connected at the electrical interface 40, with the plug contacts on the cards 42 engaged with corresponding socket contacts provided on the leaf spring fingers 44 (See FIG. 5). The protrusions 26 on the plug 24 are now vertically aligned with the recesses 86 on the heat sink base 84, as are the recesses on the plug 24 and protrusions 88 on the heat sink base 84 (FIG. 5). Because of this vertical alignment of the protrusions and corresponding recesses while in the connected position, the recesses have received the corresponding protrusions, allowing the heat sink 80 to move down into engagement with the plug, as biased by the spring fingers 76. The thermal interface material (TIM) 90 is now firmly sandwiched between the heat sink base 84 and the plug 24, providing reliable thermal conduction across the mechanical interface defined by the lower surface 85 of the heat sink base 84 and the upper surface 25 of the plug 24. In the process of moving the plug 24 axially within the socket 64, the protrusions prevent shear on the TIM 90, since the heat sink 80 does not move down into engagement with the plug until the protrusions and corresponding recesses have been vertically aligned in this connected position of FIG. 6.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An active electrical connection system, comprising:
a first connector including a plug;
a second connector including a socket configured for receiving the plug to a connected position within the socket;
active signal processing circuitry in electronic communication with one or both of the first and second connectors for processing a data signal transmitted between the first and second connector;
a heat sink including a heat sink base secured to the second connector in a position for sliding engagement with the plug at a mechanical interface between the base and the plug as the plug is moved to the connected position within the socket; and
a plurality of corresponding protrusions and recesses at the mechanical interface between the base and the plug, including protrusions on one of the heat sink base and the plug and recesses on the other of the base and the plug, wherein the protrusions are vertically misaligned with the corresponding recesses upon initial entry of the plug into the socket to urge the heat sink away from the plug, and wherein the recesses are vertically aligned with the protrusions to receive the protrusions when the plug reaches the connected position.

2. The active electrical connection system of claim 1, further comprising:
a thermal interface material applied to the heat sink, the plug, or a combination thereof at the mechanical interface between the base and the plug.

3. The active electrical connection system of claim 2, wherein the protrusions are sized to space the heat sink away from the thermal interface until the recesses have received the protrusions in the connected position.

4. The active electrical connection system of claim 1, wherein the protrusions and corresponding recesses further comprise:
a pair of protrusions on the plug spaced at a first pitch and a corresponding pair of recesses on the heat sink spaced at the first pitch, wherein the pair of recesses on the plug and the pair of protrusions on the heat sink are positioned for vertical alignment when the plug reaches the connected position.

5. The active electrical connection system of claim 4, wherein the protrusions and corresponding recesses further comprise:
a pair of recesses on the plug spaced at a second pitch and a corresponding pair of protrusions on the heat sink spaced at the second pitch, wherein the pair of recesses on the plug and the corresponding pair of protrusions on the heat sink are positioned for vertical alignment when the plug reaches the connected position.

6. The active electrical connection system of claim 5, wherein the pair of recesses on the heat sink are spaced from the pair of protrusions on the heat sink along an insertion direction of the plug into the heat sink.

7. The active electrical connection system of claim 6, further comprising:
a thermal interface material applied to the heat sink in an area between the pair of recesses on the heat sink and the pair of protrusions on the heat sink.

8. The active electrical connection system of claim 7, wherein the thermal interface material is confined within a perimeter defined by the pair of recesses on the heat sink and the pair of protrusions on the heat sink.

9. The active electrical connection system of claim 7, wherein a thickness of the thermal interface material on the heat sink is less than a height of the pair of protrusions on the heat sink.

10. The active electrical connection system of claim 1, further comprising:
an electrical interface including a plurality of electrical plug contacts and a plurality of electrical socket contacts positioned for engaging the electrical plug contacts when the plug has been moved to the connected position.

11. The active electrical connection system of claim 1, wherein the plug contacts automatically engage the corresponding socket contacts in response to the plug having been moved to the connected position.

12. The active electrical connection system of claim 1, further comprising:
a biasing member supported on the second connector and in contact with the heat sink base for biasing the heat sink base into thermal engagement with the plug at the mechanical interface between the base and the plug.

13. The active electrical connection system of claim 12, further comprising:
a heat sink retainer for movably securing the heat sink base to the second connector, the heat sink retainer comprising a collar about a periphery of the heat sink base, wherein the biasing member comprises a plurality of spring fingers inwardly extending from the collar to the base.

14. The active electrical connection system of claim 1, wherein the active circuitry comprises a microcontroller chip in the body of the first or second connector.

15. The active electrical connection system of claim 1, further comprising:
an application card comprising a circuit board, with the second connector mounted on the circuit board in electronic communication with the circuit board.
